(19) United States
(12) Patent Application Publication
(10) Pub. No.: US 2015/0039238 A1
(43) Pub. Date: Feb. 5, 2015

(54) Dispersion-Relation Fluorescence Spectroscopy

(71) Applicant: Board of Trustees of the University of Illinois, Urbana, IL (US)

(72) Inventors: Gabriel Popescu, Champaign, IL (US); Ru Wang, Champaign, IL (US)

(21) Appl. No.: 14/321,937

(22) Filed: Jul. 2, 2014

Related U.S. Application Data
(60) Provisional application No. 61/861,469, filed on Aug. 2, 2013.

(51) Int. Cl. G01N 21/64

(52) U.S. Cl. CPC G01N 21/6458; G01N 21/6408; G01N 21/6486
USPC 702/19

(57) ABSTRACT

Methods for deriving a diffusion coefficient and a drift velocity characterizing an ensemble of particles. A time series of images is acquired, and each image is Fourier transformed. An autocorrelation function is computed and fit to an exponential decay for each wave vector on a grid. A model of the diffusion-advection equation allows the decay rate Γ, expressed as a dispersion map over the wave vector plane, to yield both a diffusion coefficient and a mean drift velocity. As an example, the particles may be fluorescently excited probes where the probes label intracellular elements.

The present application claims the priority of U.S. Provisional Patent Application Ser. No. 61/861,469, filed Aug. 2, 2013, and incorporated herein by reference.

This invention was made with government support under Grants CBET0846660 CAREER and CBET1040462 MRI, both awarded by the National Science Foundation. The Government has certain rights in the invention.

### TECHNICAL FIELD

The present invention relates to apparatus and methods for analyzing transport dynamics of particles, and more particularly, for quantitatively distinguishing between directed and diffusive transport in living cells.

### BACKGROUND ART

Due to its ability to study specifically labeled structures, fluorescence microscopy is the most widely used technique for investigating live cell dynamics and function. One established method for studying molecular transport and diffusion coefficients at a fixed spatial scale is fluorescence correlation spectroscopy (FCS), or fluorescence cross-correlation spectroscopy (FCCS), as described, for example, by Bacia et al., Fluorescence cross-correlation spectroscopy in living cells, Nature Methods, vol. 3, pp. 83-89 (2006), incorporated herein by reference.

Trafficking of proteins or other molecules inside a live cell refers to their transport to appropriate positions within the cell. Trafficking is the result of both passive diffusion and active or molecular-motor-driven processes, as discussed in detail by Segev, Trafficking inside cells: pathways, mechanisms, and regulation, (Springer, 2009), which is incorporated by reference herein.

In order to understand intracellular trafficking, it is desirable to distinguish between passive diffusion and active processes with sufficient spatial and temporal resolution to identify the structure of intracellular transport networks and monitor their changes over the course of the cell cycle. Experimentally, this task is challenging due to the multitude of temporal and spatial scales involved. Diffusion of fluorescently-tagged molecules has been studied successfully by FCS as well as by fluorescence recovery after photobleaching (FRAP), described, for example, by Yao et al., Dynamics of heat shock factor association with native gene loci in living cells, Nature, vol. 442, pp. 1050-53 (2006), incorporated herein by reference. In FRAP, the temporal scales are in the range of μs-ms and the spatial scale is fixed by the excitation beam size.

The techniques of image correlation spectroscopy (ICS, described by Peterson et al., Quantitation of membrane receptor distributions by image correlation spectroscopy: concept and application, Biophysical Journal, vol. 65, pp. 1135-46 (1993)), spatiotemporal image correlation spectroscopy (STICS, described by Hebert et al., Spatiotemporal Image Correlation Spectroscopy (STICS) Theory, Verification, and Application to Protein Velocity Mapping in Living CHO Cells, Biophysical Journal, vol. 88, pp. 3601-14 (2005)), and raster image correlation spectroscopy (RICS, Digman et al., Measuring Fast Dynamics in Solutions and Cells with a Laser Scanning Microscope, Biophysical Journal, vol. 89, pp. 1317-27 (2005)) have been successfully developed to extract information about fluorophore transport. STICS complements ICS in the sense that it allows measuring the direction of the velocity, in addition to its magnitude. RICS extends ICS to faster diffusion temporal scales. Note that all the aforesaid methods use confocal scanning imaging.

For studying the transport of larger objects in the cell, e.g. organelles and vesicles, particle tracking has been used successfully, as reviewed by Waigh, Microrheology of complex fluids, Rep. Prog. Phys., vol. 68, pp. 685-742, (2005), which is incorporated herein by reference. Cells, however, contain many extended objects or continuous media, such as actin cytoskeleton, which, when viewed on scales large compared to its mesh size, cannot be resolved into separately traceable objects. For this reason, the spatiotemporal fluctuations of such continuous media cannot be investigated by particle tracking.

The requisites of having to track intracellular dynamics of a broad range of spatial and temporal scales had led to the development of quantitative phase imaging (QPI) as a label-free method capable of studying transport in live cells over a broad range of spatiotemporal scales. QPI is described, for example, by Wang et al., Dispersion-relation phase spectroscopy of intracellular transport, Opt. Express, vol. 19, pp. 20571-(2011), which is incorporated herein by reference. QPI works with intrinsic contrast and, thus, can be used indefinitely, without restrictions due to photobleaching or phototoxicity. However, it lacks specificity, i.e., it cannot report on the transport of a specific chemical species or structures.

A species-specific technique that, at the same time, facilitates dynamic studies over a broad range of spatiotemporal scales would thus be highly desirable, and a technique meeting those desiderata is described herein.

### SUMMARY OF EMBODIMENTS OF THE INVENTION

In accordance with embodiments of the invention, a method is provided for characterizing either diffusive or advective components of motion of an ensemble of fluorescent probes within a specimen. The method has steps of:
obtaining a time series of images of fluorescent intensity of the ensemble of fluorescent probes;
Fourier transforming each of the images of fluorescent intensity into wave vector space; for a plurality of wave vectors, calculating a decay time characterizing an exponential decay of an autocorrelation function of the fluorescent intensity;
applying a model of diffusion and advection to obtain a dispersion relation containing diffusion and drift components; and
fitting decay time data as a function of wave vector to obtain at least one of diffusion and drift measures characterizing the ensemble of fluorescent probes.

In accordance with alternate embodiments of the present invention, the model of diffusion and advection may yield a dispersion relation with a term proportional to a square modulus of the wave vector. The images may be two-dimensional or three-dimensional. At least one of the fluorescent probes may be linked to an intracellular structure.

In accordance with a further embodiment of the present invention, the step of fitting decay time data may provide both diffusion and drift measures characterizing the ensemble of fluorescent probes.

### BRIEF DESCRIPTION OF THE DRAWINGS

The present patent or application file contains at least one drawing executed in color. Copies of this patent with color drawing(s) will be provided by the Patent and Trademark Office upon request and payment of any necessary fee.

The foregoing features of the invention will be more readily understood by reference to the following detailed description, taken with reference to the accompanying drawings, in which:

FIG. 1A shows a fluorescence image of 1.2 μm polystyrene fluorescence beads in water under Brownian motion; FIG. 1B shows trajectories of individual beads in FIG. 1A; FIG. 1C shows fluorescence images of 1.2 μm polystyrene fluorescence beads drifting from left to right; and FIG. 1D shows trajectories of individual beads in FIG. 1C.

FIG. 2 is a flowchart depicting method steps in accordance with the present invention.

FIG. 3A shows a dispersion relation of decay rate vs. spatial mode, Γ(qₓ, q_{y}), plotted on a color scale; FIG. 3B shows an azimuthally averaged dispersion relation fit to a quadratic in wave vector; and FIG. 3C shows a plot of temporal frequency vs. the x component of spatial frequency, yielding a drift velocity, in accordance with the present invention.

### DETAILED DESCRIPTION OF EMBODIMENTS OF THE INVENTION

Definitions: The terms “object,” “sample,” and “specimen” shall refer, interchangeably, to a tangible, non-transitory physical object capable of being rendered as an image.

The term “fluorescence,” shall be used herein without limitation to encompass any process of emission of one or more photons by a medium from a quantum energetic state (typically real, but including also virtual states) that has been excited by one or more photons of incident radiation. Thus, resonant-enhanced scattering, whether single- or multiple-photon, and whether spontaneous or stimulated, is considered to be subsumed within the term “fluorescence,” as that term is used herein.

The term “image” shall refer to any multidimensional representation, whether in tangible or otherwise perceptible form, or otherwise, whereby a value of some characteristic (amplitude, phase, etc.) is associated with each of a plurality of locations corresponding to dimensional coordinates of an object in two or more dimensions of physical space, though not necessarily mapped one-to-one thereonto. Thus, for example, the graphic display of the spatial distribution of some field, either scalar or vectorial, such as brightness or color, constitutes an image. So, also, does an array of numbers, such as a 3D holographic dataset, in a computer memory or holographic medium. Similarly, “imaging” refers to the rendering of a stated physical characteristic in terms of one or more images.

In the present context, a “dispersion relation” shall refer generally to the functional relationship between the wave vector associated with a phenomenon characterized by propagation (real or virtual) in a medium, and any temporal quantity. Thus, for example, any time-dependent linear partial differential equation on an unbounded space, such as a diffusion-advection equation, as in the present case, has solutions that may be expressed as a linear combination of plane waves, e^{i(qr-ωt)}, where r and t are spatial and temporal coordinates respectively, and the functional relationship between q and ω constitutes the dispersion relation. It is to be understood that in spaces of dimension greater than unity, q and r represent vectors, and their scalar product is to be understood. More particularly, the phenomenon measured may be an autocorrelation, as discussed below.

In accordance with the present invention, fluorescence of objects is measured in at least two dimensions as a function of time. Many techniques for acquiring fluorescence data are well known, and those, as well as any to be discovered in the future, are within the scope of the present invention, in that the present invention is not limited to any particular method of acquiring the fluorescence data, but, rather, concerns the manner in which those data are processed, and information derived therefrom.

In any modality studying the dynamics of a system, the intensity of a signal is measured as a function of spatial position, and time. Here, what is measured, is the intensity I(x,y;t) of fluorescence by molecular probes that have been linked to structures of interest in a cell, for example. Dynamic information about the probes resides in the second-order autocorrelation function:

$${g}^{( 2 )} ( q ; τ ) = \frac{〈 I ( t ) I ( t + τ ) 〉}{{〈 I ( t ) 〉}^{2}} ,$$

where q is the wavevector, and, in the most general case, q is a vector of the dimensionality of the spatial data acquired. It is to be understood that the present invention is not limited to two dimensions, and while, solely for heuristic convenience, the presentation herein assumes that a time-series of two-dimensional images has been obtained for processing, extension to three dimensions can be readily performed by persons of ordinary skill in the art, given three dimensional data. The modulus |q| is represented herein as q.

Assuming that the autocorrelation function depends on the correlation time τ as a simple exponential decay of decay rate Γ, the decay rate may be derived from the fluorescence data as a function of q, or, in the two-dimensional case, as Γ(qₓ, q_{y}).

The continuity equation dictates that, in the absence of sources or sinks, the time rate of change of a conserved quantity (here, the intensity I of fluorescent probes) within a volume is equal to the divergence of a flux j through the boundary of that volume. The flux j may be broken down into the sum of a diffusive part and an advective part,

j=j_{dif}+j_{adv},

and the continuity equation, with the flux separated in this manner, may be referred to herein as the diffusion-advection equation. The diffusive part may be expressed as a scalar diffusion coefficient D times the gradient of the diffusing quantity, here I: j_{dif}=D ∇I, as enunciated by Adolf Eugen Fick in 1855, during his tenure at the University of Zurich. The advective part of the flux, on the other hand, is represented by a velocity v: j_{adv}=Iv. In the context of intracellular elements such as vesicles or organelles, advective velocities can be expected to be well-characterized by homogeneously-broadened Lorenzian distribution, with a central velocity v₀ and a linewidth Δv.

Using the standard diffusion-advection representation just described, having isotropic (diffusion) and anisotropic (advection) components, the normalized density autocorrelation function reflects the dispersion relation among the coefficients of the diffusion-advection equation, and becomes:

g(q;τ)=e^{iv}^{₀}^{·qr}e^{-Δqτ-Dq}^{²}^{τ},

such that the decay rate is:

Γ(q)=Δvg+Dq².

Insofar as Γ(q) is a function relating the wave vector q to a temporal quantity (the decay time associated with an exponential fit to the decay of an autocorrelation function), Γ(q) is, itself, a dispersion relation. Generally, an effective dispersion relation may be cast in the form of a power law, Γ(q)˜q^{a}, which describes the relaxation rate of the spatial mode q, with 1/Γ describing the characteristic time of moving particles to travel a mean distance of 1/q. The current inventors have discovered that, insofar as the autocorrelation function reflects the separation of the dispersion relation into isotropic and anisotropic components, it becomes possible to derive diffusive and advective contributions on the basis of measurements performed on an ensemble of particles, without tracking individual particles.

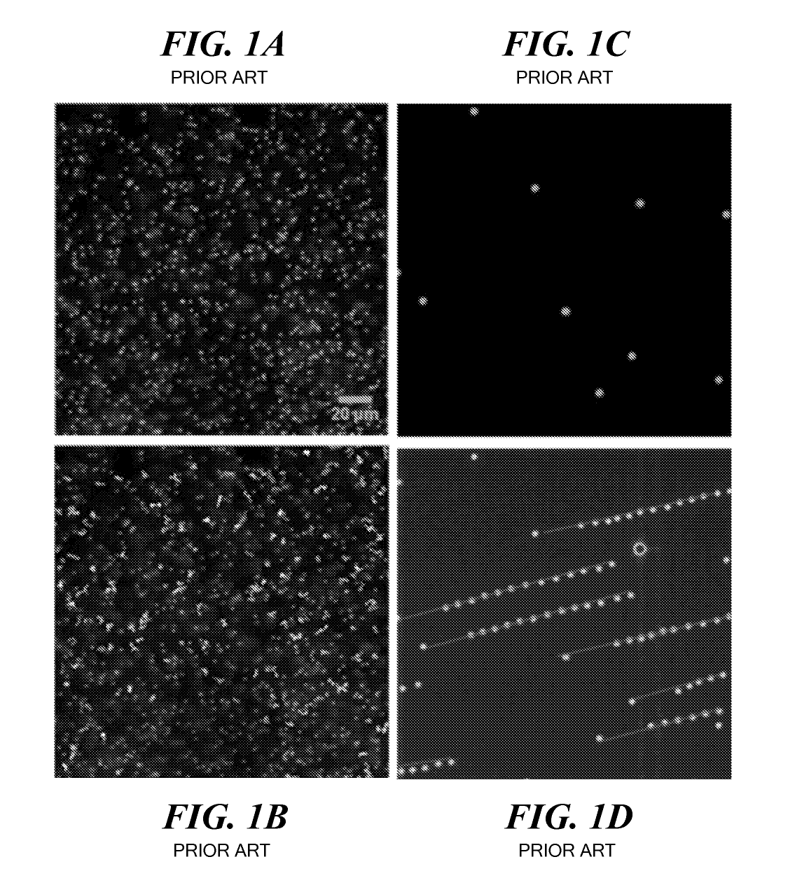

In accordance with the invention disclosed herein, a time series of images is obtained in which fluorescent intensity due to fluorescence of probe-labeled intracellular elements is imaged as a function of coordinates in two- (or three-) dimensional space in each time frame. The resultant intensity images are represented as I(x, y; t). When the separation of isotropic and anisotropic contributions is derived from the dispersion relation of the ensemble of probes in the aggregate, the method employed may be referred to as “Dispersion-Relation Fluorescence Spectroscopy” or “DFS.” The method, in accordance with the present invention, of separately deriving isotropic and anisotropic components of a flux from measurements applied to an ensemble and from a derived dispersion relation, may advantageously obviate the tracking of individual particles. The prior tracking of individual particles, in this case, drifting 1.2-μm-diameter polystyrene beams imaged under fluorescence spectroscopy, is shown in FIGS. 1A-1D. FIG. 1A shows a fluorescence image of 1.2 μm polystyrene fluorescence beads in water under Brownian motion; FIG. 1B shows trajectories of individual beads in FIG. 1A; FIG. 1C shows fluorescence images of 1.2 μm polystyrene fluorescence beads drifting from left to right; and FIG. 1D shows trajectories of individual beads in FIG. 1C.

Spatially resolved measurements of the exponential decay time of the normalized density autocorrelation function may be referred to herein as “DFS signals.”

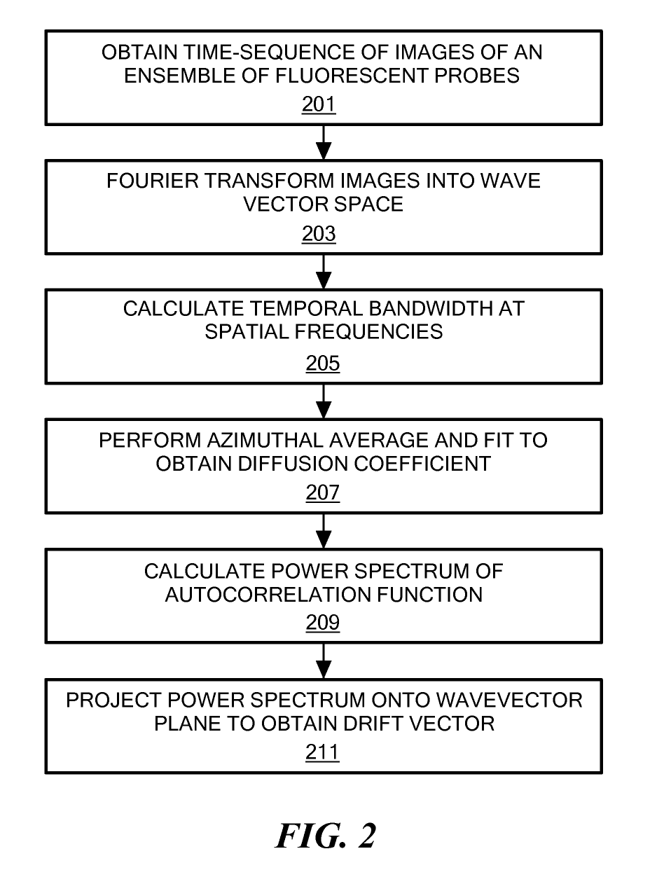

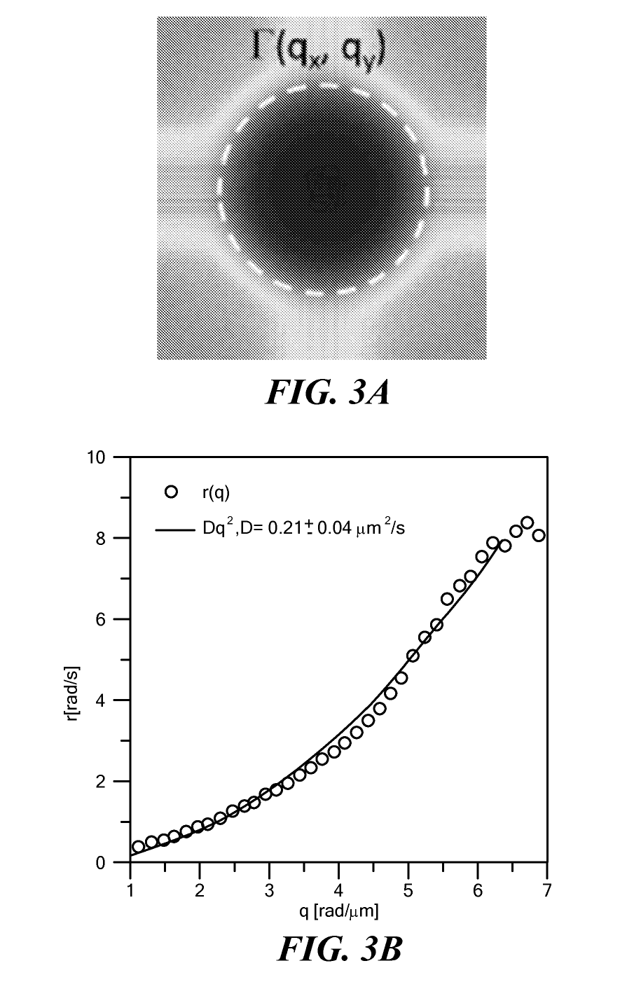

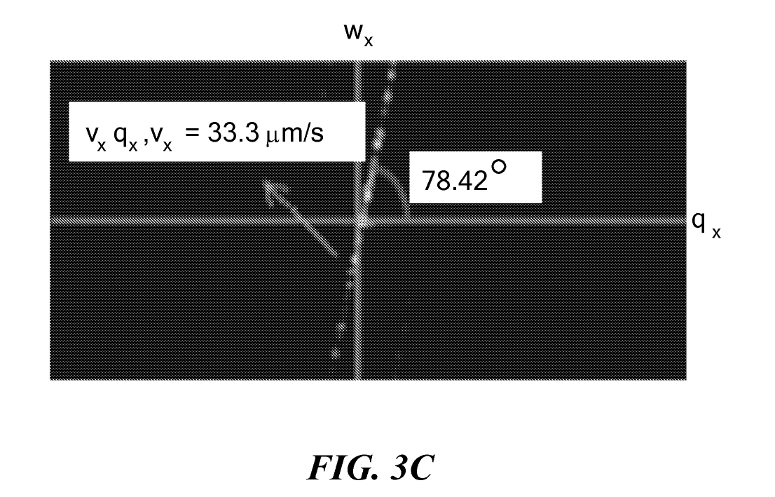

Steps in accordance with the present invention are depicted in the flowchart of FIG. 2. Fluorescent intensity I (x,y), arising from a specimen containing particles labeled with fluorescent probes and excited to induce fluorescence, is imaged (201) at a plurality of times or temporal frames. Each frame is Fourier transformed (203) into wave vector space, and the temporal bandwidth F is calculated (205) at each spatial frequency (qₓ, q_{y}) on a grid, according to well-known algorithms. The dispersion relation is in the form of a power law, Γ(q)˜q^{α}, describes the relaxation rate, Γ, (in rad/s) of the spatial mode q (in rad/μm). Physically, 1/F describes the correlation time associated with a spatial disturbance of wavelength 1/q. The shorter the wavelength (higher q), the shorter the time (higher Γ). The dispersion relation of decay rate vs. spatial mode, Γ(qₓ, q_{y}), is plotted on a color scale, in FIG. 3A. An azimuthal average is performed (207) in the (qₓ, q_{y}) plane, providing a plot of Γ(q) shown in FIG. 3B, and a fit to the diffusion coefficient D. The power spectrum P(ω, q) of the normalized density autocorrelation function is also calculated (209) at each point in the (qₓ, q_{y}) plane.

The drift velocity produces a shift in the power spectrum at a frequency equal to (q)=v·q, (as described in detail in Berne et al., Dynamic Light Scattering with Applications to Chemistry, Biology and Physics, pp. 73-79 (Dover, ed. 2000), which is incorporated herein by reference, effectively constituting a q-dependent Doppler frequency shift. The projection (211) of ω(q) onto the qₓ and q_{y} axes, respectively, yields the respective components of the drift velocity vector.

### EXAMPLE

As an example demonstrating that dynamic properties of an ensemble of particles may indeed be derived from the fluorescence of labeled particles, experiments were performed in S2 drosophila cells, whose peroxisomes were labeled with green fluorescent protein. The images were acquired at rate 1 sec/frame up to 2 minutes with epi-fluorescence microscopy. DFS, as described above, was applied to the acquired images and a diffusion component was found in the motion of peroxisome at time scales of the order of seconds, with D=(9 ±1)×10^{-3 μm}²/s, which agreed with that obtained from particle tracking. This demonstrated that DFS can be easily implemented to study motions of discrete particles in live cells, without the need for particle tracking.

In accordance with certain embodiments of the present invention, aspects of the analysis of an ensemble of labeled particles may be implemented as a computer program product for use with a computer system. Such implementations may include a series of computer instructions fixed either on a tangible medium, which is preferably non-transient and substantially immutable, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method for characterizing diffusive and advective components of motion of an ensemble of fluorescent probes within a specimen, the method comprising:
a. obtaining a time series of images of fluorescent intensity of the ensemble of fluorescent probes;
b. Fourier transforming each of the images of fluorescent intensity into wave vector space;
c. for a plurality of wave vectors, calculating a decay time characterizing an exponential decay of an autocorrelation function of the fluorescent intensity;
d. applying a model of diffusion and advection to obtain a dispersion relation containing diffusion and drift components; and
e. fitting decay time data as a function of wave vector to obtain at least one of diffusion and drift measures characterizing the ensemble of fluorescent probes.

2. A method in accordance with claim 1, wherein the model of diffusion and advection yields a dispersion relation with a term proportional to a square modulus of the wave vector.

3. A method in accordance with claim 1, wherein the images are two-dimensional.

4. A method in accordance with claim 1, wherein at least one of the fluorescent probes is linked to an intracellular structure.

5. A method in accordance with claim 1, wherein fitting decay time data provides both diffusion and drift measures characterizing the ensemble of fluorescent probes.
